(19) United States
(12) Patent Application Publication
(10) Pub. No.: US 2026/0280928 A1
(43) Pub. Date: Sep. 17, 2026

(54) CONTROL OF A HOUSEHOLD APPLIANCE

(71) Applicant: BSH Hausgeräte GmbH, München (DE)

(72) Inventor: Christoph KOBER, Otterfing (DE)

(21) Appl. No.: 19/471,397

(22) PCT Filed: Apr. 25, 2024
(86) PCT No.: PCT/EP2024/061369

§ 371 Date: Oct. 1, 2025

(30) Foreign Application Priority Data
May 2, 2023 (DE) 10 2023 204 034.4

(51) Int. Cl. H04L 12/28; D06F 34/05

(52) U.S. Cl. CPC H04L 12/2834; D06F 34/05; H04L 2012/285

(57) ABSTRACT

A system contains a household appliance which can be controlled on the basis of a function parameter. The household appliance is configured to store first function parameters, and an external location is configured to store first and second function parameters. The first function parameters of the household appliance and the second function parameters can be edited by an application connected to the external location. In the process, the first function parameters are transmitted from the household appliance to the external location.

The present invention relates to the control of a household appliance. In particular, the invention relates to the control of a household appliance by means of different input devices.

A household appliance comprises a processing facility and a data storage device. The data storage device can store a function parameter which can be used to control an operation of the household appliance. By way of example, the household appliance can comprise a washing machine, and different function parameters can be provided for treating hot-water laundry, colored laundry, or delicate laundry. A user can change such a function parameter on the device and thus adapt a function of the household appliance to their requirements.

It is possible for operating elements of the household appliance to be unsuitable for extensive adaptations of function parameters. It is therefore customary to limit a number of function parameters of the household appliance which can be changed on the device itself. If the user wishes to change or rather set further function parameters, they can use an application which runs for example on a smartphone. A set or rather changed function parameter can then be uploaded onto the household appliance. If the household appliance is not permanently connected to a network for communicating with the smartphone, an exchange can also take place via an entity external to the household appliance. In this case, a function parameter can be synchronized in a first step with the external entity and with the household appliance in a second step.

If function parameters are changed from different applications, overlaps can occur, which can cause a function parameter to become unclear or misleading. This can result in a misconfiguration that can jeopardize the operation of the household appliance.

One of the objects underlying the present invention is to provide an improved technique for controlling a household appliance with regard to a function parameter. The invention achieves this object by means of the subjects of the independent claims. Subordinate claims reflect preferred embodiments.

According to a first aspect of the invention, a system comprises a household appliance that can be controlled on the basis of a function parameter (and/or on the basis of first and second function parameters), wherein the household appliance is configured to store first function parameters (and, in one embodiment, optionally also second function parameters). Furthermore, the system comprises an entity external to the household appliance which is configured to store first and second function parameters. The first function parameters can be changed and/or edited at the household appliance and the second function parameters can be changed and/or edited by means of an application connected to the external entity. The first function parameters are transmitted from the household appliance to the external entity. In one embodiment, the first function parameters can be transmitted unidirectionally, i.e., only from the household appliance to the external entity, but not in the opposite direction. In a further embodiment, the first function parameters can also be changed from the external entity.

By distinguishing between first and second function parameters, different data sovereignties (single source of truth) can be set. For each data sovereignty, an entity can be defined where, in the event of a conflict, the respective valid value for a function parameter is available. This prevents conflicting changes to a function parameter from leading to an undefined state, an invalid function parameter, or the household appliance becoming inoperable in terms of control. The external entity can serve as a cache for first function parameters for an application. This allows the application to always display valid first and second function parameters and, under certain circumstances, edit them.

In one embodiment, the household appliance has data sovereignty over the first function parameters and the external entity has data sovereignty over the second function parameters, so that in the event of a conflict (and/or an inconsistency between function parameters stored at different locations), the respective valid value for a first function parameter is available at the household appliance and the respective valid value for a second function parameter is available at the external entity.

It is preferred that a change to a first function parameter at the external entity and/or a transmission of a changed first function parameter to the household appliance is only possible if a communication connection exists between the household appliance and the external entity.

It is thus possible to ensure that data sovereignty over the first function parameters remains with the household appliance. A user can conveniently edit a first function parameter by means of the application without running the risk of causing a misconfiguration or rather a competing change to a first function parameter.

For a function of the household appliance, one of the function parameters can be selected and the function controlled on the basis of the selected function parameter. The function parameter can be selected at the household appliance or by means of the application. If a second function parameter has been selected, it can be loaded into the household appliance from the external entity before the function of the household appliance is controlled. It is preferable that the transmission of a second function parameter from the external entity to the household appliance is controlled automatically.

The transmission of the second function parameter is further preferably unidirectional. It is preferable that a change to a second function parameter at the household appliance and/or the transmission of a changed second function parameter to the external entity is excluded. The transmission of a second function parameter from the household appliance to the external entity cannot be provided for. In another embodiment, a transmission attempt by the household appliance and/or by the external entity can be rejected.

In the event of an interrupted communication connection between the household appliance and the external entity, a first function parameter that has been changed at the household appliance can be determined and transmitted to the external entity when the communication connection is restored. For example, a first function parameter can be assigned a flag indicating that the function parameter has been changed. When the communication connection to the external entity becomes available again, all flagged function parameters can be transmitted to the external entity. In another embodiment, all first function parameters can be transmitted to the external entity when the communication connection is restored. In addition, first function parameters can be transmitted to the external entity periodically, for example.

The external entity is further preferably configured to transmit a change in a stored first or second function parameter to a connected application. A first function parameter can be changed by receiving an updated first function parameter from the household appliance. The second function parameter can be changed by means of another application connected to the external entity. The change can be transmitted to all connected applications so that data consistency can be established across the applications. If a new application is connected to the external entity, currently valid first and/or second function parameters can be transmitted to the application.

It is generally preferred that multiple applications can be connected to the external entity concurrently. Accordingly, concurrently competing changes to second function parameters can also be made via the applications. Standard means of conflict resolution can be used for this purpose. For example, an application can temporarily protect a second function parameter against write access by another application. The function parameter can only be changed by another application after the first application has relinquished its exclusive control. In another embodiment, any competing changes to a second function parameter by different applications can be tolerated. The respective last state of the second function parameter can be transmitted to all connected applications.

The function parameter can in particular comprise a function program executable on the household appliance. The function program can comprise further parameters, wherein a parameter can be predetermined within the context of the function program, determined at execution time, or specified by a user when the function program is started. A complexity of the function program is usually only limited by the comprehensibility of a user's interaction with an application for editing the function program.

The household appliance can comprise one of a laundry care appliance, a kitchen appliance, or a cleaning appliance. As a laundry care appliance, the household appliance can comprise, for example, a washing machine or a dryer. As a kitchen appliance, it can comprise, for example, an extractor hood, a hob, an oven, a steam cooker, a refrigerator, or a dishwasher. As a cleaning appliance, the household appliance can, for example, be designed as a vacuum cleaner, a hand-held universal appliance (multi-use hand stick, MUH), an iron, or an ironing station. Another household appliance can also be used.

The application can run on a personalized device, in particular a smartphone, a laptop computer, or a tablet computer. In further possible embodiments, the application runs, for example, on a smart watch, a voice-controlled assistant, or a home automation control center. The device can be assigned to a user of the household appliance. In a further embodiment, control can also be effected by any web-enabled device, for example via an Internet browser that can run on a desktop computer.

According to a further aspect of the present invention, a household appliance that can be controlled on the basis of a function parameter comprises a first storage device for storing first function parameters; an interface for communicating with an external entity; and a processing facility for transmitting the first function parameters from the household appliance to the external entity.

The household appliance can support a selection and/or transmission of a function parameter from the external entity. The household appliance can be comprised by a system described herein. Features or advantages of the household appliance can be transmitted to the system, or vice versa.

In one embodiment, the household appliance can be controlled on the basis of first and second function parameters. In some embodiments, the storage device can also be used to store second function parameters. It is preferred that the household appliance is configured to allow the first function parameters to be changed, set, and/or edited at the household appliance. In some embodiments, the household appliance can have data sovereignty over the first function parameters so that, in the event of a conflict (and/or inconsistency between function parameters stored at different locations), the respective valid value for a first function parameter is available at the household appliance.

The external entity can be formed by an apparatus comprising a second storage device for storing first and second function parameters for controlling a predetermined household appliance. The apparatus also comprises a first interface for transmitting first function parameters from the household appliance; a second interface for connecting to a predetermined application; and a processing facility which is configured to edit a second function parameter under the control of the application.

The apparatus can also be comprised by a system described herein. Features or advantages of the apparatus can be transmitted to the system or vice versa.

In some embodiments, the apparatus has data sovereignty over the second function parameters so that, in the event of a conflict (and/or inconsistency between function parameters stored at different locations), the respective valid value for a second function parameter is available on the apparatus.

Non-limiting embodiments of the invention are now described in detail with regard to the attached figures, in which:

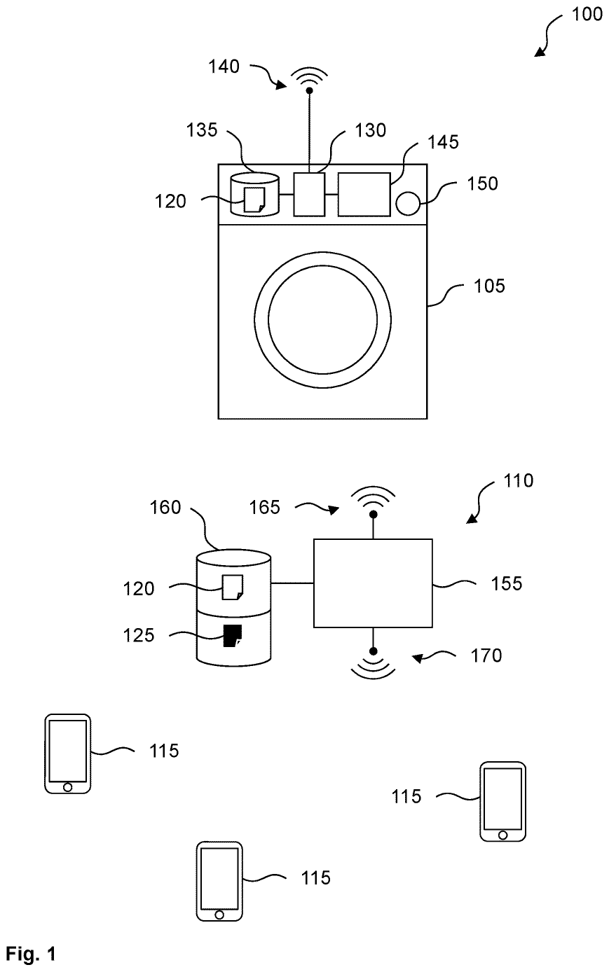

FIG. 1 shows a system;

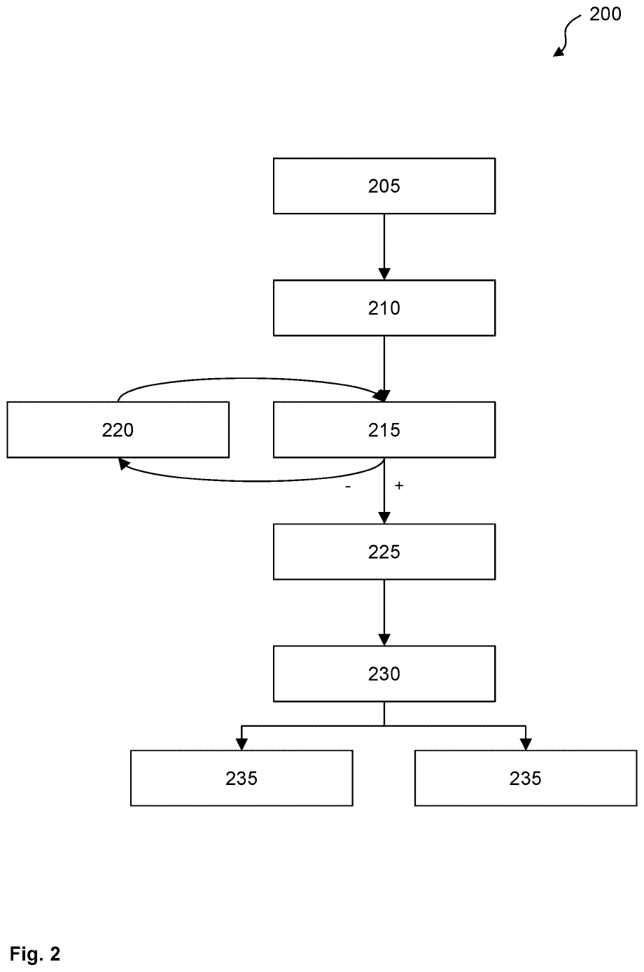

FIG. 2 shows a flow diagram of a first method;

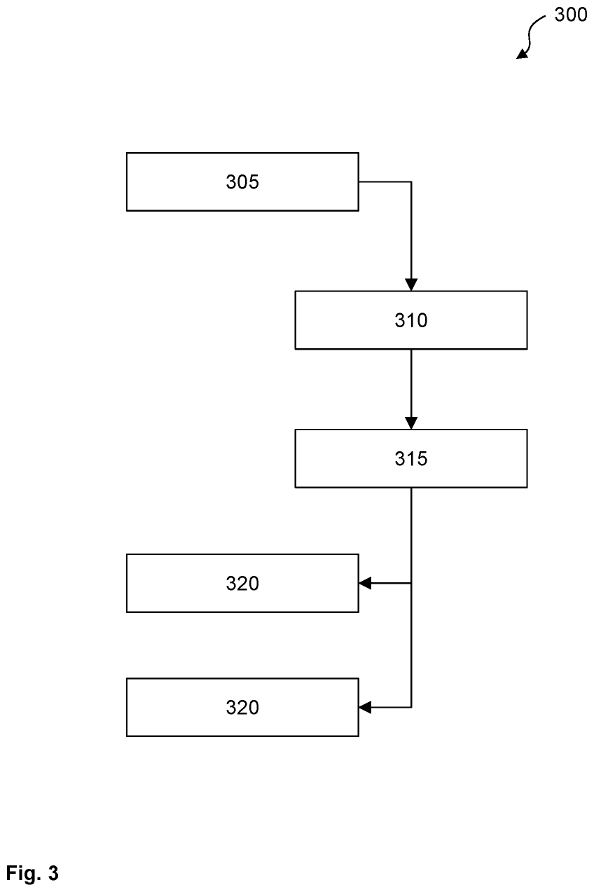

FIG. 3 shows a flow diagram of a second method; and

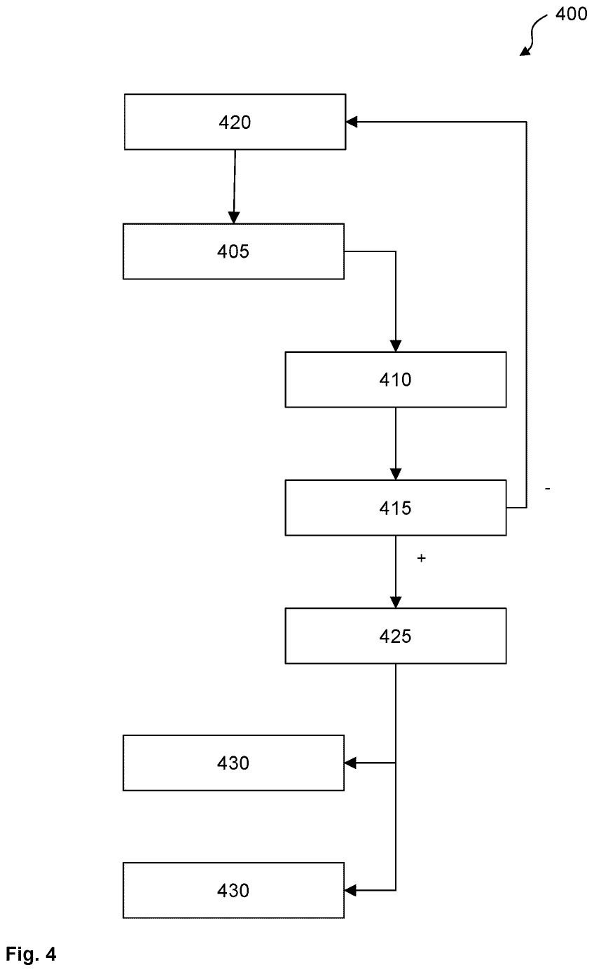

FIG. 4 shows a flow diagram of a third method.

FIG. 1 shows a system 100 for controlling a household appliance 105. The system 100 comprises the household appliance 105 and an entity 110 external to the household appliance 105. In addition, it can comprise one or more applications 115 which can be formed in each case by a device which can be controlled by a user of the household appliance 105.

The household appliance 105 can be controlled on the basis of a function parameter which can comprise an individual parameter, a collection of parameters or a function program. The function parameter can be selected from different data sources. A first function parameter 120 can be controlled at the household appliance 105 itself by a user. A second function parameter 125 can be edited by means of an application 115 at the external entity 110.

The household appliance 105 preferably comprises a processing facility 130, a first storage device 135 for storing one or more first function parameters 120 and an interface 140 for communicating with the external entity 110. In addition, an output facility 145 and/or an input facility 150 is preferably provided. The output facility 145 can comprise an optical display facility, for example. Other possibilities comprise an acoustic or haptic output facility 145. The input facility 150 is illustrated by way of example as a rotary knob; in other embodiments, the input facility 150 can however also comprise, for example, keys, a touch-sensitive screen or another input means. A user can call up, change and store a first function parameter 120 in the first storage device 135 by means of the interaction facility 145, 150.

The interface 140 is preferably wireless and can operate by means of Bluetooth, WLAN, or mobile communications, for example. FIG. 1 does not illustrate a receiver for wireless signals from the interface 140. The receiver can establish a connection to a wired network. In another embodiment, the interface 140 is wired.

For illustrative purposes only, the household appliance 105 in FIG. 1 is designed as a washing machine. The function parameter 120 can comprise a function program of the washing machine 105, which can be set or changed by a user.

The entity 110 external to the household appliance 105 is preferably configured to communicate with a plurality of household appliances 105. However, it is possible that functions performed by different household appliances 105 do not overlap, so that only operation with a single household appliance 105 is described here. The external entity 110 can be implemented, for example, as a server or as a service, in particular in a cloud.

The external entity 110 preferably comprises a processing facility 155, a second storage device 160, a first interface 165, and a second interface 170. The external entity 110 can communicate with the household appliance 105 via the first interface 165. Although the first interface 165 is shown with a symbol for a wireless connection, a wired connection can also be used. The external entity 110 can communicate with one or more applications 115 by means of the second interface 170. Here, too, part of the transmission path can be wireless and/or another part wired. Usually, an application 115 is connected to the external entity 110 by means of a wide area communication network. The Internet or a mobile communications network can be used for this purpose, for example.

The second storage device 160 is configured to store first function parameters 120 and second function parameters 125. An application 115 can view, change, and re-save first and second function parameters 120, 125 of the external entity 110. Predetermined restrictions can apply, as explained in more detail herein.

Conceptually, the first storage device 135 of the household appliance 105 is considered to be the facility where the currently valid first function parameters 120 are stored. If, for any reason, a conflict arises between first function parameters 120 at different locations, the relevant value is always found in the first storage device 135. Similarly, the second storage device 160 of the external entity 110 can be considered the authoritative data source for second function parameters 125. If, for any reason, different values for a second function parameter 125 exist at different locations in the system 100, the relevant value is always found in the second storage device 160.

It should be noted that the external entity 110 is preferably configured to communicate concurrently with multiple applications 115, each of which can access the same second function parameter 125. Conventional methods can be used to avoid collisions, for example semaphores, mutex passages, spinlocks, or priorities.

The change or distribution of function parameters 120, 125 in the system 100 is described in more detail below with the aid of three examples.

FIG. 2 shows a flowchart of a first exemplary method 200 in which a user-controlled change to a first function parameter 120 at the household appliance 105 is made.

In step 205, a first function parameter 120 can be edited at the household appliance 105. This can be done in particular by means of the interaction facilities 145, 150 by a user of the household appliance 105. In step 210, the change can be stored locally in the first storage device 135.

In step 215, it can be checked whether a communication connection between the household appliance 105 and the external entity 110 is available. If this is not the case, the first function parameter that was changed can be noted in step 220. After a predetermined time, it can be checked again in step 215 whether the connection is available. In a further embodiment, an event-driven check can also be performed.

If it was determined in step 215 that the connection is available, the changed function parameter can be transmitted to the external entity 110 in step 225. The changed first function parameter 120 can be stored in the second storage device 160 in step 230. The change can then be forwarded to one or more connected applications 115 in one or more steps 235. A user of the household appliance 105 who is using an application 115 can be notified immediately via a changed first function parameter 120.

FIG. 3 shows a flowchart of a second method 300 in which a second function parameter 125 is changed on an application 115. This change can be made in particular by a user of the household appliance 105.

In step 305, it can be detected that a user has changed a second function parameter 125 on an application 115. The change can be transmitted to the external entity 110 in step 310. In step 315, the affected, changed second function parameter 125 can be stored locally in the second storage device 160 or overwritten. Subsequently, in step 320, the change can be transmitted to one or more other applications 115.

It should be noted that, in the context of a user-controlled change to a second function parameter 125, it is preferable that transmission to the household appliance 105 does not take place. Only when a second function parameter 125 is to be used as the basis for a function of the household appliance 105 can the corresponding selected function parameter 125 be transmitted to the household appliance 105.

FIG. 4 shows a flowchart of a third method 400 in which a first function parameter 120 is changed on an application 115. This change can also be made by a user of the household appliance 105.

In step 405, it can be detected that a first function parameter 120 is being changed in one of the applications 115. In step 410, the change can be transmitted to the external entity 110.

In step 415, it can be checked whether a communication connection between the external entity 110 and the household appliance 105 is available. If this is not the case, in step 420, a corresponding message can be sent to the application 115 via which the change was made. In particular, the change to the application 115 can be reversed. Optionally, a further change to a first function parameter 120 can be blocked by a user on the application 115. A change to a second function parameter 125 by means of an application 115 cannot be affected by this.

Otherwise, if it was determined in step 415 that the communication connection to the household appliance 105 is available, the first function parameter 120 can be stored in the second storage device 160 in step 425. In one or more subsequent steps 430, the changed first function parameter 120 can be transmitted to one or more other connected applications 115.

### REFERENCE CHARACTERS

100 System
105 Household appliance
110 External entity
115 Application
120 First function parameter
125 Second function parameter
130 Processing facility
135 First storage device
140 Interface
145 Output facility
150 Input facility
155 Processing facility
160 Second storage device
165 First interface
170 Second interface
200 First method
205 First function parameter edited by a user at the household appliance
210 Store the change locally
215 Connection available?
220 Note the first function parameter to be changed
225 Transmit the change to an external entity
230 Store the change at an external entity
235 Forward the change to a connected application
300 Second method
305 Second function parameter edited by a user using an application
310 Transmit the change to an external entity
315 Store the change locally
320 Transmit the change to a further application
400 Third method
405 First function parameter edited by a user using an application
410 Transmit the change to an external entity
415 Communication connection to the household appliance available?
420 Reset
425 Store the change locally
430 Transmit the change to a further application

1-14. (canceled)

15. A system, comprising:
a household appliance being controlled on a basis of a function parameter, wherein said household appliance being configured to store first function parameters;
an application; and
an external entity configured to store the first function parameters and second function parameters, wherein a first function parameter of the first function parameters is edited at said household appliance and a second function parameter of the second function parameters is edited by means of said application connected to said external entity, wherein the first function parameters are transmitted from said household appliance to said external entity.

16. The system according to claim 15, wherein a change to the first function parameter at said external entity and/or a transmission of a changed first function parameter to said household appliance is only possible if a communication connection exists between said household appliance and said external entity.

17. The system according to claim 15, wherein for a function of said household appliance, one of said first function parameters or said second function parameters is selected and the function is controlled on a basis of a selected function parameter.

18. The system according to claim 17, wherein a selected second function parameter is transmitted from said external entity to said household appliance.

19. The system according to claim 18, wherein a change to one of the second function parameters at said household appliance and/or a transmission of a changed second function parameter to said external entity is excluded.

20. The system according to claim 16, wherein in an event of an interrupted communication connection between said household appliance and said external entity, the first function parameter that has been changed at said household appliance is determined and transmitted to said external entity when the communication connection is restored.

21. The system according to claim 15, wherein said external entity is configured to transmit a change to a stored first function parameter or a stored second function parameter to a connected application.

22. The system according to claim 21, wherein a plurality of applications can be connected to said external entity concurrently.

23. The system according to claim 15, wherein the function parameter includes a function program executable on said household appliance.

24. The system according to claim 15, wherein said household appliance is a laundry care appliance, a kitchen appliance, or a cleaning appliance.

25. The system according to claim 15, wherein said application can run on a smartphone, a laptop computer, a tablet computer, a smart watch, a voice-controlled assistant, or a home automation control center.

26. The system according to claim 15, wherein said household appliance has data sovereignty over the first function parameters and said external entity has data sovereignty over the second function parameters, so that in an event of a conflict, a currently valid value for the first function parameter is available at said household appliance and a currently valid value for the second function parameter is available at said external entity.

27. A household appliance being controlled on a basis of a function parameter, the household appliance comprising:
a storage device for storing first function parameters;
an interface for communicating with an external entity; and
a processor for transmitting the first function parameters from the household appliance to the external entity.

28. An apparatus, comprising:
a storage device for storing first and second function parameters for controlling a predetermined household appliance;
a first interface for transmitting the first function parameters from the predetermined household appliance;
a second interface for connecting to a predetermined application; and
a processor configured to edit a second function parameter under a control of the predetermined application.
